(19) United States
(12) Patent Application Publication
(10) Pub. No.: US 2023/0132466 A1
(43) Pub. Date: May 4, 2023

(54) HOSE JOINT

(71) Applicant: TZU-CHING GUO, Taipei City (TW)

(72) Inventor: TZU-CHING GUO, Taipei City (TW)

(21) Appl. No.: 17/514,220

(22) Filed: Oct. 29, 2021

(51) Int. Cl. F16L 19/02

(52) U.S. Cl. CPC F16L 19/0206

(57) ABSTRACT

A joint is used to connect two hoses to each other without having to rotate the hoses relative to each other. The joint includes two connectors, an adapter and a ring. Each of the connectors is connected to one of the hoses. The first connector is connected to the adapter while the ring is located between a section of the first connector and a portion of the adapter longitudinally while the ring is allowed to rotate relative to the combination of the first connector with the adapter. The ring is engaged with and disengaged from the second connector by rotating the ring relative to the second connector.

### BACKGROUND OF INVENTION

### 1. Field of Invention

The present invention relates to hoses and, more particularly, to a joint for connection two hoses.

### 2. Related Prior Art

For extinguishing fire or gardening, hoses are used to transmit water from sources such as fire hydrants or faucets to sites where water is needed. There are different distances between the sources and the sites where water is needed. Hence, different lengths of hoses are needed. In practice, multiple hoses are used. Some of the hoses are interconnected when the source is at a long distance from the site where water is needed. To interconnect the hoses, quick-release joints are used.

Referring to FIG. 14, two hoses S1 and S2 are interconnected by a conventional quick-release joint including two connectors 91 and 92. The hose S1 is connected to the connector 91 so that they are not rotatable relative to each other. The hose S2 is connected to the connector 92 so that they are not rotatable relative to each other.

The connector 91 includes multiple flanges 911 insertable in multiple grooves 922 of the connector 92. The connector 92 includes multiple flanges 921 insertable in multiple grooves 912 of the connector 91. Thus, the connector 91 is engageable with the connector 92.

To respectively insert the flanges 911 and 921 in the grooves 922 and 912 or to respectively move the flanges 911 and 921 from the grooves 922 and 912, the connectors 91 and 92 are translated to each other before they are rotated relative to each other. Accordingly, the hose S1 must be rotated relative to the hose S2. It is inevitable to twist the hoses S1 and S2 in an attempt to rotate the hose S1 relative to the hose S2 because of their length.

In a fire-fighting task, the hoses S1 and S2 are made of certain rigidity against twisting and hence considerable weight. Hence, it is troublesome to rotate the hose S1 relative to the hose S2 because of their weight and rigidity. It would be more so when there is water in the hoses S1 and S2. Sometimes, it requires more than one person to rotate the hose S1 relative to the hose S2.

The present invention is therefore intended to obviate or at least alleviate the problems encountered in the prior art.

### SUMMARY OF INVENTION

It is the primary objective of the present invention to provide a joint for connecting two hoses to each other without having to rotate the hoses relative to each other.

To achieve the foregoing objective, the joint includes two connectors, an adapter and a ring. The first connector includes an axial channel and a thread formed on a wall of the axial channel. The second connector includes an axial channel and a transverse groove and longitudinal groove in an external face. The transverse groove is in communication with the longitudinal groove. The adapter includes an axial channel, two terminal sections and a middle section. The first terminal section includes a thread engaged with the thread of the first connector so that the axial channel of the adapter is coaxial with the axial channel of the first connector. The second terminal section is insertable in the axial channel of the second connector. The middle section is formed between the first and second terminal sections. The ring includes a central aperture, a central space and a fin. The central aperture receives the middle section of the adapter. The central space receives a section of the second connector when the second connector receives the second terminal section of the adapter. The fin is formed on a wall of the central space. The fin is insertable in the transverse groove via the longitudinal groove to connect the ring to the second connector.

Other objectives, advantages and features of the present invention will be apparent from the following description referring to the attached drawings.

### BRIEF DESCRIPTION OF DRAWINGS

The present invention will be described via detailed illustration of three embodiments referring to the drawings wherein:

FIG. 1 is a perspective view of a hose joint according to the first embodiment of the present invention;

FIG. 2 is a cross-sectional view of the hose joint shown in FIG. 1;

FIG. 3 is an exploded view of the hose joint shown in FIG. 1;

FIG. 4 is an exploded view of the hose joint at another angle than shown in FIG. 3;

FIG. 5 is another exploded view of the hose joint shown in FIG. 1;

FIG. 6 is a perspective view of the hose joint shown in FIG. 1, showing how to engage a connector of the hose joint with another connector of the hose joint;

FIG. 7 is a cross-sectional view of the hose joint shown in FIG. 6;

FIG. 8 is a cross-sectional view of the hose joint in another position than shown in FIG. 7;

FIG. 9 is a side view of a nozzle connected to a hose by the hose joint shown in FIG. 1;

FIG. 10 is a cross-sectional view of a hose joint according to the second embodiment of the present invention;

FIG. 11 is a perspective view of a connector of a hose joint according to the third embodiment of the present invention;

FIG. 12 is a side view of the hose joint shown in FIG. 11;

FIG. 13 is a cross-sectional view of a ring of the hose joint shown in FIG. 11; and

FIG. 14 is an exploded of two hoses connected to each other by a conventional hose joint.

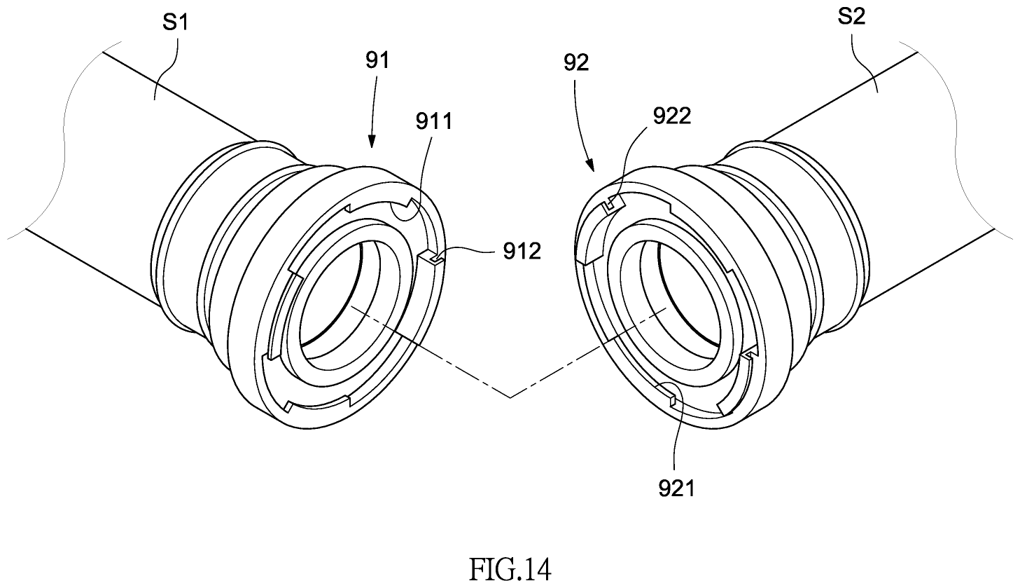

### DETAILED DESCRIPTION OF EMBODIMENTS

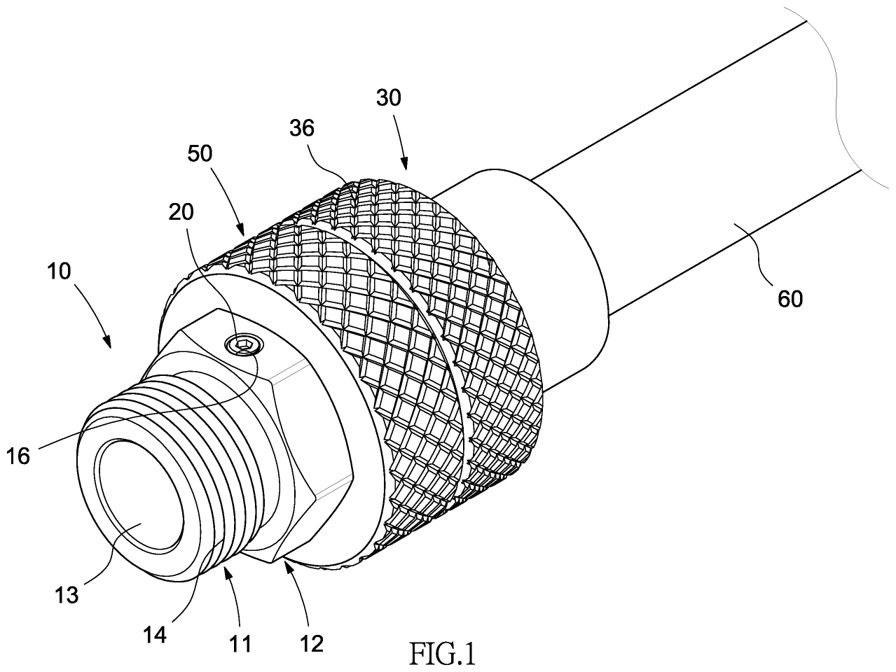

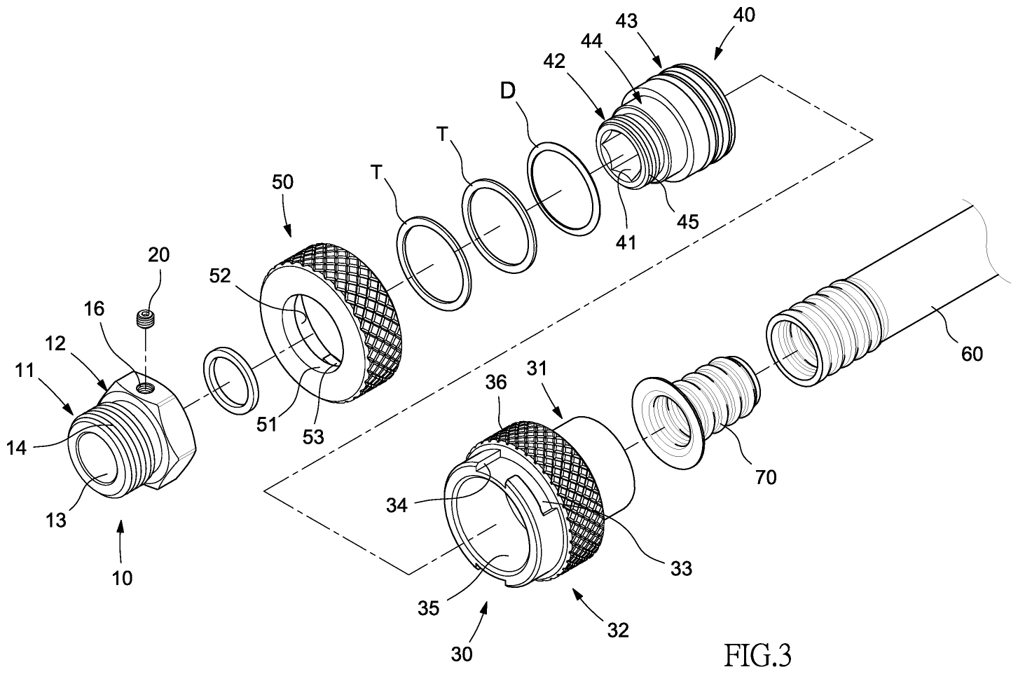

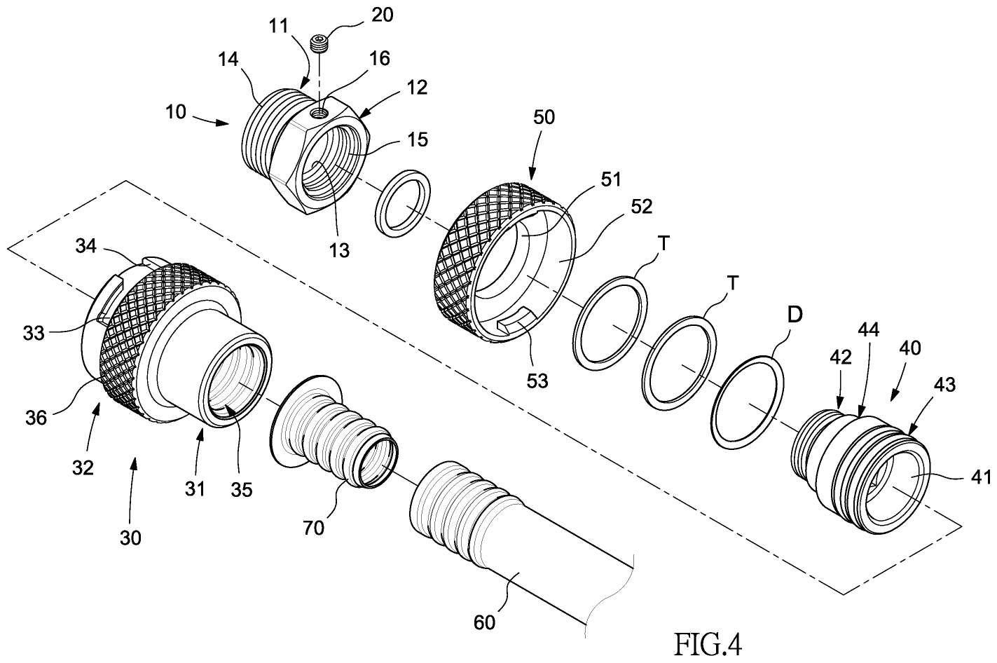

Referring to FIGS. 1 through 5, a hose joint includes two connectors 10 and 30, a screw 20, an adapter 40 and a ring 50 according to a first embodiment of the present invention. A hose 60 is connected to the connector 30 in operation.

The connector 10 includes a circular section 11, a non-circular section 12, an axial channel 13, two threads 14 and 15 and a lateral screw hole 16. The circular section 11 and the non-circular section 12 are formed at two opposite ends of the connector 10. An external diameter of the circular section 11 is smaller than an external dimension of the non-circular section 12.

The axial channel 13 extends throughout the connector 10. The axial channel 13 includes a smaller section in the circular section 11 and a larger section in the non-circular section 12. A shoulder (not numbered) is formed between the smaller and larger sections of the axial channel 13.

The thread 14 extends on an external face of the circular section 11. The thread 15 extends on an internal face of the larger section of the axial channel 13.

The lateral screw hole 16 extends throughout the non-circular section 12 in a radial manner. The lateral screw hole 16 is in communication with the larger section of the axial channel 13. The lateral screw hole 16 receives the screw 20.

The connector 30 includes a smaller circular section 31, a larger circular section 32, several transverse grooves 33, several longitudinal grooves 34, an axial channel 35 and an anti-skid section 36. The smaller circular section 31 and the larger circular section 32 are formed at two opposite ends of the connector 30. An external diameter of the smaller circular section 31 is smaller than an external diameter of the larger circular section 32.

Each of the transverse grooves 33 extends in an external face of the larger circular section 32 in a circumferential direction of the connector 30. Each of the longitudinal grooves 34 extends in the external face of the larger circular section 32 in a longitudinal direction of the connector 30. Each of the longitudinal grooves 34 is in communication with a corresponding one of the transverse grooves 33. Each of the longitudinal grooves 34 includes an open end at a free end of the larger circular section 32.

The axial channel 35 extends throughout the connector 30. The axial channel 35 includes a larger section 351 and a smaller section 352. A shoulder (not numbered) is formed between the larger section 351 and the smaller section 352. Annular protuberances 3521 extend from a wall of the smaller section 532 of the axial channel 35.

The anti-skid section 36 extends on the external face of the larger circular section 32 in a circumferential direction. The anti-skid section 36 is located next to the transverse groove 33.

The adapter 40 includes an end connected to the connector 10 and another end inserted in the larger section 351 of the axial channel 35 of the connector 30 in use. The adapter 40 includes an axial channel 41, a smaller terminal section 42, a larger terminal section 43 and a middle section 44.

The axial channel 41 extends throughout the adapter 40. The axial channel 41 includes a polygonal section for receiving a polygonal section of a tool (not shown).

The terminal sections 42 and 43 are formed at two opposite ends of the adapter 40. The smaller terminal section 42 is formed with a thread 45 for engagement with the thread 15 of the connector 10 to connect the adapter 40 to the connector 10 in use. The screw 20 is inserted in the lateral screw hole 16 of the connector 10 so that a tip of the screw 20 abuts against the smaller terminal section 42 of the adapter 40 to ensure the connection of the connector 10 to the adapter 40.

The middle section 44 of the adapter 40 is formed between the smaller terminal section 42 and the larger terminal section 43. An external diameter of the middle section 44 of the adapter 40 is larger than an external diameter of the smaller terminal section 42 but smaller than an external diameter of the larger terminal section 43 and the external dimension of the non-circular section 12 of the connector 10.

The ring 50 includes a central aperture 51, a central space 52 and at least one fin 53.

The central aperture 51 and the central space 52 are made in the ring 50, at two opposite ends of the ring 50. The central aperture 51 is in communication with the central space 52. A diameter of the central aperture 51 is smaller than a diameter of the central space 52. The fins 53 extend on a wall of the central space 52.

In operation, the ring 50 receives the middle section 44 of the adapter 40. The central aperture 51 is coaxial with the axial channel 13. The middle section 44 of the adapter 40 extends through the central aperture 51 of the ring 50. A diameter of the central aperture 51 of the ring 50 is smaller than the external diameter of the larger terminal section 43 of the adapter 40. Thus, the ring 50 is confined between the connector 10 and the larger terminal section 43 of the adapter 40 while the ring 50 is allowed to rotate relative to the connector 10 and the larger terminal section 43 of the adapter 40. The fins 53 of the ring 50 are inserted in the transverse grooves 33 of the connector 30 through the longitudinal grooves 34.

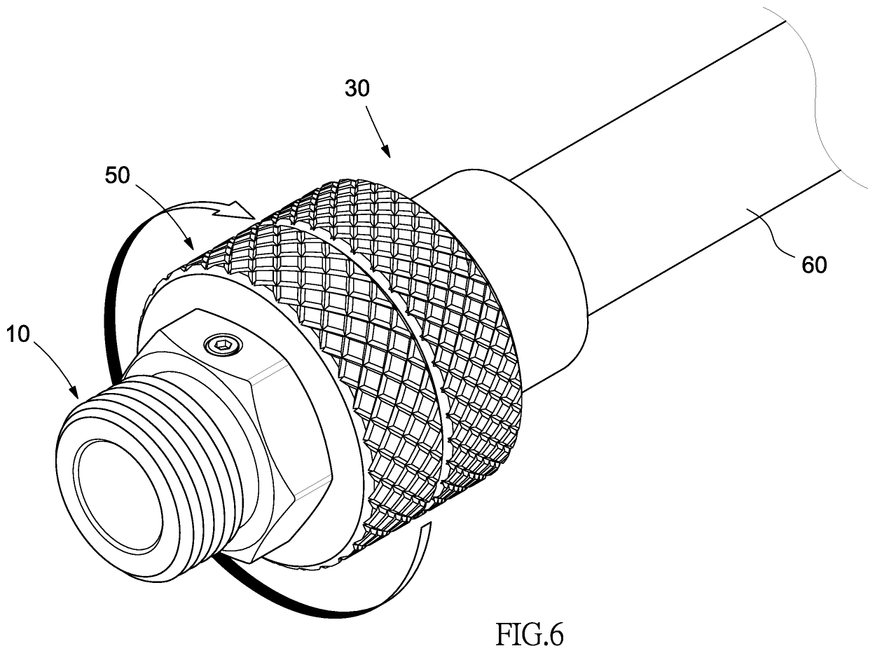

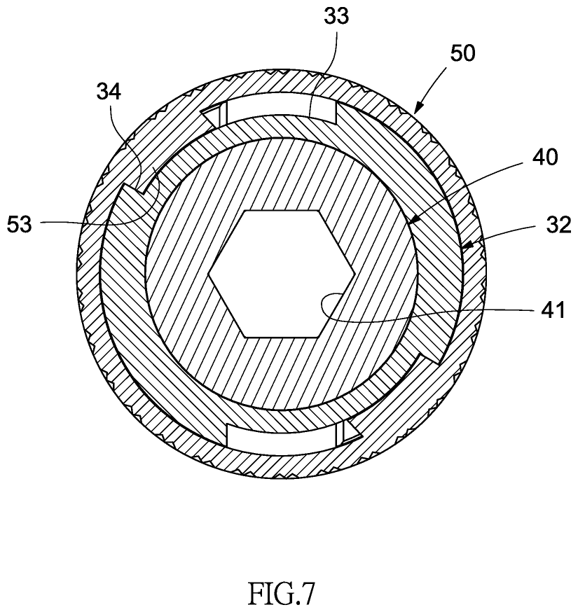

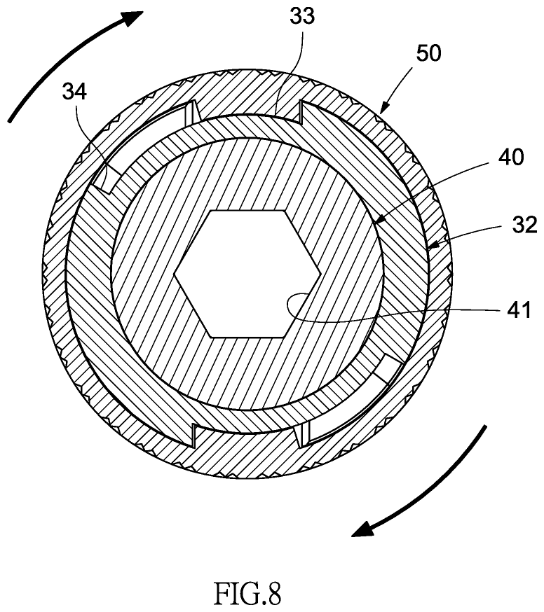

The components of the hose joint have been described above. The use of the hose joint will be described referring to FIGS. 1 through 9.

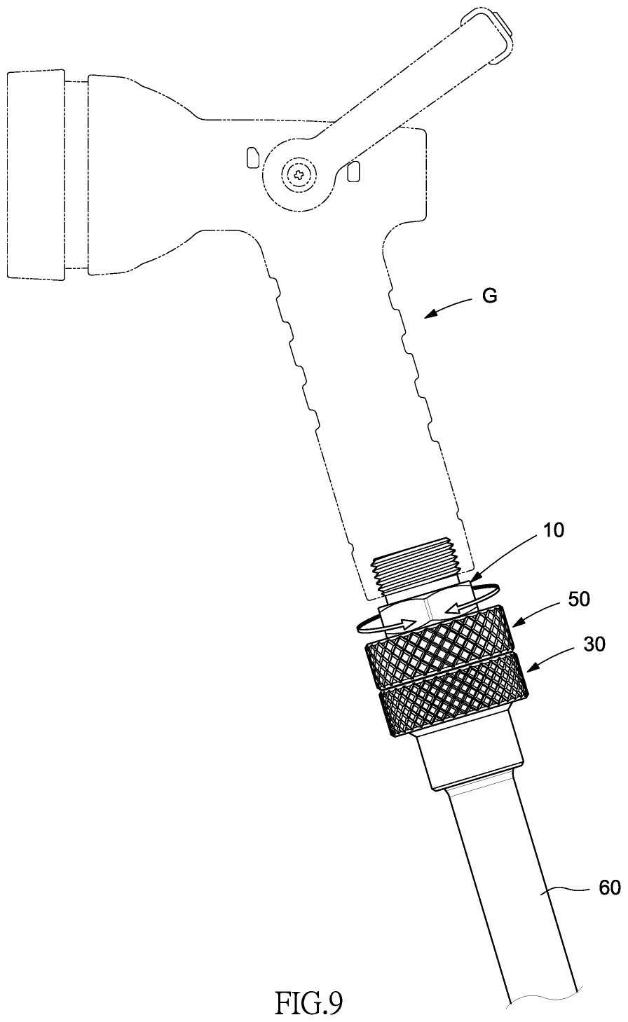

Referring to FIG. 9, the thread 14 of the connector 10 is engaged with a thread (not numbered) formed on an internal face of a nozzle G. The connector 30 is connected to a hose 60. To this end, an end of the hose 60 is inserted in the smaller section 352 of the axial channel 35 of the connector 30.

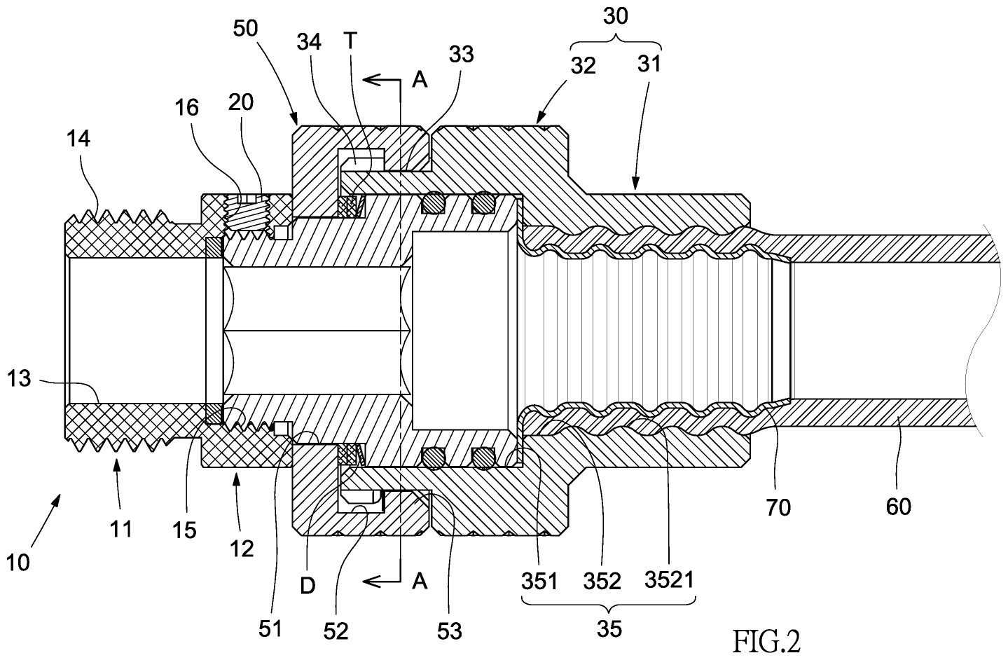

Referring to FIG. 2, a lining 70 made of metal such as copper is inserted in the smaller section 352 of the axial channel 35. Thus, a section of the hose 60 is kept between the lining 70 and the connector 30. The lining 70 is pressed form inside so that the lining 70 is deformed and hence includes annular portions (not numbered) in compliance with the annular protuberances 3521 of the smaller section 352 of the connector 30. Thus, the section of the hose 60 is kept on the lining 70 and in the smaller section 352 of the axial channel 35 of the connector 30 in a longitudinal direction.

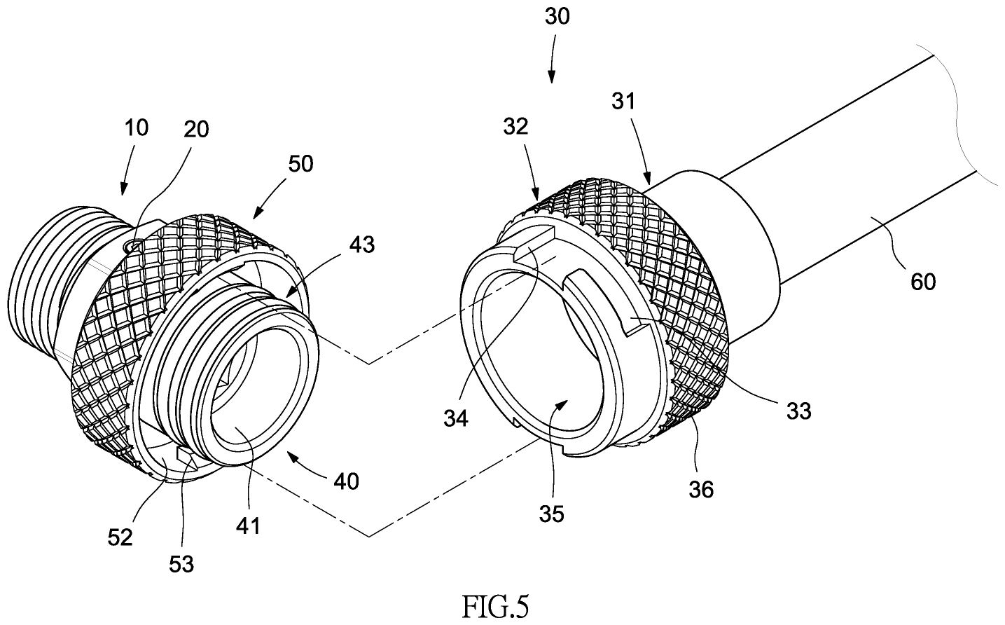

Referring to FIGS. 5 through 9, to interconnect the connectors 10 and 30, the larger terminal section 43 of the adapter 40 is inserted in the axial channel 35 of the connector 30, and the circular section 32 of the connector 30 is inserted in the central space 52 of the ring 50. The ring 50 is moved to the connector 30 in an axial direction to move the fins 53 in the longitudinal grooves 34. Then, the ring 50 is rotated to move the fins 53 in the transverse grooves 33 of the connector 30 so that an end of each of the fins 53 reaches a closed end of a corresponding one of the transverse grooves 33. Thus, the connectors 10 and 30 are interconnected without having to rotate the nozzle G, which is connected to the connector 10, relative to the hose 60, which is connected to the connector 30.

The combination of the connector 10 with the adapter 40 is rotatable relative to the ring 50 and the connector 30. When the nozzle G is rotated, the combination of the connector 10 with the adapter 40 is rotated relative to the connector 30 and the ring 50. Thus, the connector 30 and the hose 60 are not rotated.

Referring to FIGS. 2 through 4, to render the ring 50 smoothly rotatable, at least one Teflon ring T is located around the middle section 44 of the adapter 40. The Teflon ring T keeps the ring 50 from the larger terminal section 43 of the adapter 40. Friction between the Teflon ring T and the ring 50 plus friction between the Teflon ring T and the larger terminal section 43 of the adapter 40 is smaller than friction between the ring 50 and the larger terminal section 43 of the adapter 40.

At least one conical washer D (or Teflon ring) is located around the middle section 44 of the adapter 40. The conical washer D (or Teflon ring) is sandwiched between the ring 50 and the larger terminal section 43 of the adapter 40 to preload the ring 50 in rotation and translation relative to the adapter 40.

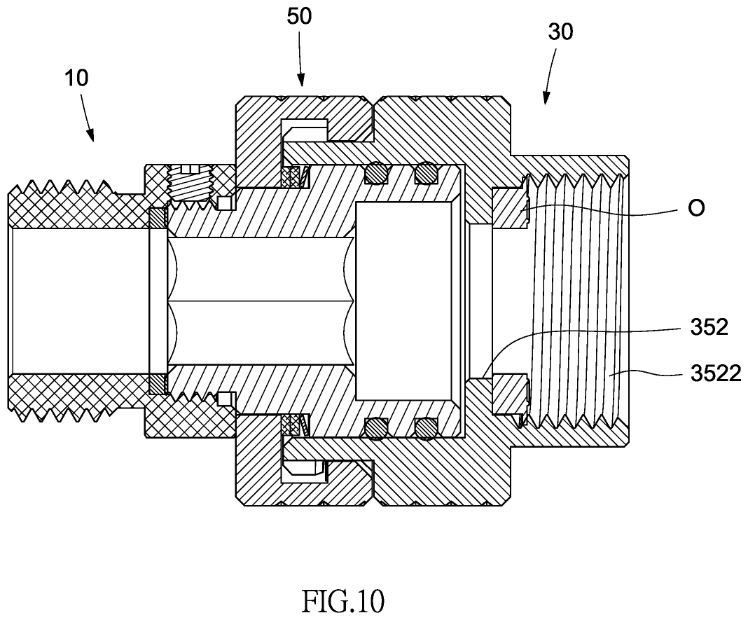

Referring to FIG. 10, a hose joint according to a second embodiment of the present invention is shown. The second embodiment is like the first embodiment except for two things. Firstly, the connector 30 includes a thread 3522 instead of the annular protuberances 3521. Secondly, there is an additional ring O located against an internal flange (not numbered) in the smaller section 352 of the second axial channel 35.

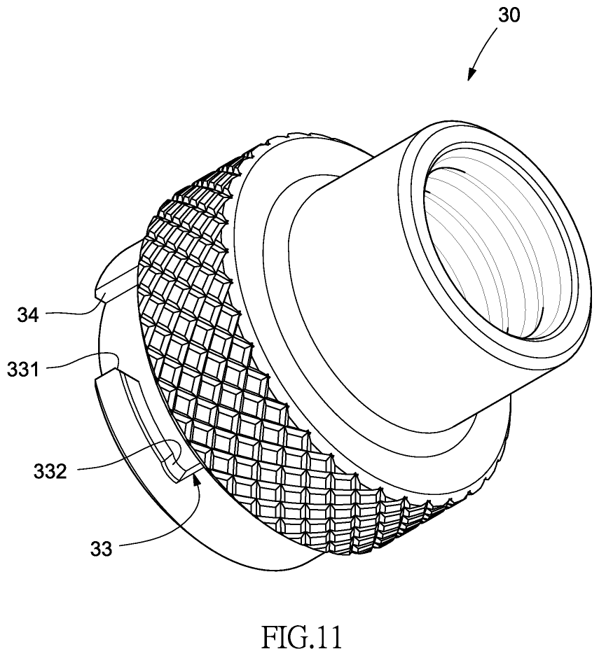

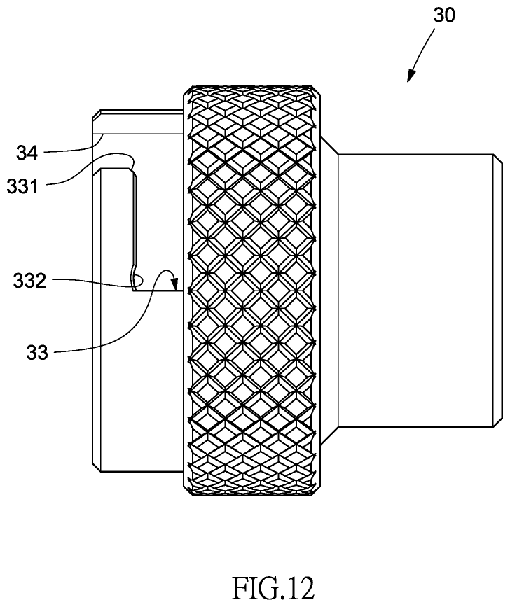

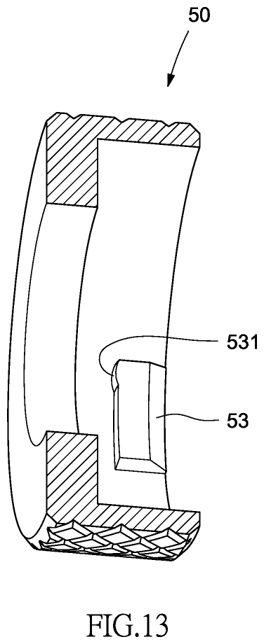

Referring to FIGS. 11 through 13 a hose joint according to a third embodiment of the present invention is shown. The third embodiment is like the first embodiment except for three things. Firstly, an arched portion of the connector 30 extending along each of the transverse grooves 33 includes a chamfer 331 at a point where the transverse groove 33 meets the corresponding longitudinal groove 34. The chamfers 331 facilitate movement of the fins 53 into the transverse grooves 33 via the longitudinal grooves 34.

Secondly, the arched portion of the connector 30 extending along each of the transverse grooves 33 includes a recess 332 near the closed end of the transverse groove 33.

Thirdly and accordingly, each of the fins 53 of the ring 50 includes a boss 531. The bosses 531 are insertable in the recesses 332 to help keep the ring 50 in position relative to the connector 30.

The present invention has been described via the illustration of the embodiments. Those skilled in the art can derive variations from the embodiments without departing from the scope of the present invention. Therefore, the embodiments shall not limit the scope of the present invention defined in the claims.

1. A hose joint comprising:
a first connector comprising an axial channel and a thread formed on a wall of the axial channel;
a second connector comprising an axial channel and a transverse groove and longitudinal groove in an external face, wherein the transverse groove is in communication with the longitudinal groove;
an adapter comprising:
an axial channel;
a first terminal section comprising a thread engaged with the thread of the first connector so that the axial channel of the adapter is coaxial with the axial channel of the first connector;
a second terminal section insertable in the axial channel of the second connector; and
a middle section formed between the first and second terminal sections; and
a ring comprising:
a central aperture for receiving the middle section of the adapter;
a central space for receiving a section of the second connector when the second connector receives the second terminal section of the adapter; and
a fin formed on a wall of the central space, wherein the fin is insertable in the transverse groove via the longitudinal groove to connect the ring to the second connector.

2. The hose joint according to claim 1, wherein the first connector comprises a lateral screw hole for receiving a screw formed with a tip abutted against the adapter.

3. The hose joint according to claim 1, comprising a Teflon ring (T) located between the ring and the middle section of the adapter in a radial manner.

4. The hose joint according to claim 1, wherein the axial channel of the adapter comprises a polygonal section.

5. The hose joint according to claim 1, wherein the second connector comprises an anti-skid section formed on an external face.

6. The hose joint according to claim 1, comprising a metal lining for abutting inserted in a hose against a wall of the axial channel of the second connector.

7. The hose joint according to claim 1, wherein the second connector comprises a thread formed on a wall of the axial channel thereof.

8. The hose joint according to claim 1, wherein the second connector comprises a plurality of annular protuberances formed on a wall of the axial channel thereof.

9. The hose joint according to claim 1, wherein the second connector comprises a chamfer in a portion where the transverse groove meets the longitudinal groove.

10. The hose joint according to claim 1, wherein the second connector comprises a recess in communication with the transverse groove, wherein the ring comprises a boss extending from the fin, wherein the boss is inserted in the recess to help keep the ring in position relative to the second connector.

11. The hose joint according to claim 1, wherein the middle section is made with an external dimension larger than an external dimension of the first terminal section but smaller than an external dimension of the second terminal section.
